(19) United States
(12) Patent Application Publication
(10) Pub. No.: US 2006/0269288 A1
(43) Pub. Date: Nov. 30, 2006

(54) High density optical harness

(75) Inventors: Daniel Guidotti, Atlanta, GA (US); Gee-Kung Chang, Smyrna, GA (US)

Correspondence Address: MERCHANT & GOULD PC, P.O. BOX 2903, MINNEAPOLIS, MN, 55402-0903, US

(73) Assignee: Georgia Tech Research Corporation, Atlanta, GA (US)

(21) Appl. No.: 11/439,091

(22) Filed: May 23, 2006

Related U.S. Application Data
(60) Provisional application No. 60/685,903, filed on May 31, 2005.

(51) Int. Cl. H04B 10/00

(52) U.S. Cl. 398/135

(57) ABSTRACT

A flexible optical harness containing lasers and photodetectors that are pre-aligned to light conduits may be provided. Light may be transmitted through an optical conduit comprising a core region surrounded by a cladding region. The coupling between optical conduits and emitting laser and receiving photodetector occurs via an interface between each designated optical conduit and between each photodetector and each designated optical conduit. A detector's active area forms an interface with the designated light conduit's core. The laser's emission area forms an interface with the designated light conduit's core. The said optical harness may, in addition, be combined with a flexible conducting harness between common blocks.

### RELATED APPLICATION

Under provisions of 35 U.S.C. § 119(e), Applicants claim the benefit of U.S. Provisional Application No. 60/685,903, filed May 31, 2005, which is incorporated herein by reference.

### BACKGROUND

Since the 1830s, commercial long distance communications has relied on electrically conducting wires. The science and technology for communicating information over long distances gradually changed in the late 1970s with the advent of reliable semiconductor lasers and low loss optical fibers. Long distance optical communication can support much higher information transfer rates over much longer distances and with much less power expenditure than is possible with electrical wires. With incremental improvements in long distances optical communications, this communications mode will remain in service for the foreseeable future.

A sequence of events similar to optical long distance communication is occurring over a much more compressed time scale and over very short distances. Since the 1940s, digital computing has used conducting wires (i.e. interconnects and data bus) for transferring information back and forth among central logic units and memory storage devices, to other computers, and to the external human interfaces. Modern computers are useful due to their high processing speeds. The same physical principles that limit long distance communications via conducting wires, however, also limits information transmission at high speeds over short distances. These principles are founded in the laws of electricity and magnetism and the physical properties of matter and can be expressed in the following terms: i) a conductor's resistance to current flow; ii) a conductor's capacity to hold or store charge; iii) the generation of magnetic inductance by a flowing current; iv) the emission of electromagnetic radiation by an accelerating or decelerating charge; and v) the behavior of these basic quantities as the rate of charge movement increases. In other words, the net effect is that as the rate of information transfer increases or the width of an electrical pulse or bit along the time axis decreases, the distance over which conducting interconnects are able to transmit that information decreases.

The limited ability of electrical interconnects to carry high bandwidth information over a few meters or even a few centimeters in computer chassis for connecting boards or connecting chips is well recognized as is the solution of using optical interconnects. Conventional flexible and rigid optical interconnects are represented, for example, by the article by Takashi Yoshikawa, et al., published in the year 2000 in the Proceedings of the IEEE, Volume 88, pages 849-855, and also by the Ibiden corporation (see website at URL http://www.aist.go.ip/aist e/latest research/2005/20051026/20051026.html). These make use of discrete mirrors and/or lenses that are assembled and aligned largely by hand. Consequently conventional solutions are expensive, bulky, and can only provide a small number of channels, usually less than twenty four, for intra-board applications that would be better served by ten times that many optical channels. In addition, conventional optical interconnects are completely unsuitable for an inter-chip applications that require a large number of optical channels (e.g. greater than one thousand) distributed over a limited space, for example.

### SUMMARY

An optical harness having high channel density may be provided. This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter.

A high optical channel density harness may be provided. Detectors and lasers in the harness may be simultaneously aligned with their respective light guiding channel. Each detector and laser may form an interface with its respective light guiding channel. Light may not leave the light guiding channel until it is absorbed by the detector. Manual assembly and bulkiness that limits the density of conventional optical channels are solved by the harness that may be used for both inter-board and inter-chip optical interconnects. Embodiments of the present invention may include a flexible collection of light conduits containing pre-aligned lasers and photodetectors that can be referred to as an optical strap or an optical harness. Furthermore, the collection of light conduits containing pre-aligned lasers and photodetectors may be constructed on a rigid or flexible platform.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a cross-section view of an optical harness comprising a flexible array of light guiding optical conduits terminating on transmitter-receiver modules;

FIG. 2 is a cross-section view of an optical harness comprising a flexible array of light guiding optical conduits and an array of electrical lines terminating on transmitter-receiver modules;

FIG. 3 is a cross-section of the direct optical end-coupling between a flexible light guiding optical conduit and an edge emitting laser with top and bottom electrical contacts and mounted on a flip-chip substrate for convenient interface with electronic circuits;

FIG. 4 is a cross-section view of the optical coupling between a flexible light guiding optical conduit and a vertically emitting laser with top and bottom electrical contacts and mounted on a flip-chip substrate for convenient interface with electronic circuits;

FIG. 5 is a cross section view of the optical coupling between a flexible light guiding optical conduit and a vertically viewing photodetector with top and bottom electrical contacts and mounted on flip-chip substrate for convenient interface with electronic circuits;

FIG. 6 shows a direct end-coupling of an edge-viewing photodetector to a flexible light guiding optical conduit mounted on flip-chip substrate for convenient interface with electronic circuits;

FIG. 7 shows a direct end-coupling of an edge-viewing photodetector at one end, to a flexible light guiding optical conduit on the receiver module of the transceiver, and a direct end-coupling of an edge-emitting laser at the other end to a same flexible light guiding optical conduit on the transmitter module of the transceiver;

FIG. 8 shows the multiple channel flexible optical harness connecting to arrays of lasers, photodetectors and supporting electronics; and

FIG. 9. shows the multiple channel flexible optical harness, with accompanying electrical harness offset for clarity, connecting to arrays of lasers, photodetectors and supporting electronics.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Consistent with an embodiment of the present invention, a system for providing optical communication between two or more electronic circuits may comprise a light source, a light conduit, and a light detector in which the amplitude and/or emitted light's phase vary to encode a signal. The light detector records the encoded signal in proportion to the variations in the amplitude and/or emitted light's phase with minimal error. The conduit of light comprises suitable construction and materials so as to guide the light from the source to the detector with minimal loss. Both the laser and detectors each forms an interface with their assigned conduit of light and each is simultaneously self-aligned with its assigned light conduit during a parallel fabrication process. One light source may thus be self aligned to many light detectors when the light conduit has many branches and each branch member is self aligned to a detector. Many light conduits may be clustered in an array and each may be self aligned to lasers and detectors in a one-to-one correspondence or a one-to-many correspondence. The light conduits array may be flexible and may carry plural optical signals on one side and plural electrical signals on the other side. Or both electrical and optical signals may be carried on the same side or multiple flexible levels. This flexible embodiment may be referred to as the optical harness.

According to another embodiment, a method may be provided for high speed optical communications between two or more electronic circuits comprising lasers and detectors and light guiding optical conduits. The lasers and detectors may form an interface with the light guiding optical conduits. The optical alignment may occur during a parallel fabrication process. In this embodiment, the lightwave network or array may be formed on a rigid platform that may also contain electronic circuits.

According to another embodiment, a method may be provided for high speed optical communication among electronic circuits. The method may use the optical harness or a rigid platform in which the light sources are lasers that emit light in a predominantly vertical direction relative to their electrical contacts plane and detectors that view incoming light in a predominantly vertical direction with respect to their electrical contacts plane. The lasers and detectors may form an interface with the light guiding optical conduits and the optical self alignment may occur during a parallel fabrication process. If light is to be transported in a plane that is predominantly perpendicular to the light emission and detection directions, then an additional fabrication sequence may form angled facets on each light conduit predominantly over the active areas of both laser and detector in order to launch light in the predominantly horizontal plane or receive light from a predominantly horizontal plane relative to the direction of light emission and detection.

According to another embodiment, a method may be provided for high speed optical communication among electronic circuits. The method may use the optical harness or a rigid platform in which the light sources are lasers that emit light in a predominantly horizontal direction and parallel to the plane of their electrical contacts and detectors that view incoming light in a predominantly horizontal direction and parallel to the plane of their electrical contacts. In all cases, the lasers and detectors may form an interface with the light guiding optical conduits and the optical self alignment may occur during a parallel fabrication process. If light is to be transported in a plane that is predominantly parallel to the light emission and detection directions, then the active areas of the lasers and detectors become directly end-coupled to the light guiding optical conduit.

In accordance with another embodiment, a mix of vertically emitting lasers, vertically viewing photodetectors, edge emitting lasers, and edge viewing photodetectors may be used to construct the optical harness or on a rigid platform. In this case an additional fabrication sequence may form angled facets on each light guiding conduit predominantly over the active areas of both vertically launching laser and vertically receiving detector in order to launch light in the predominantly horizontal plane of propagation or receive light from a predominantly horizontal plane relative to the direction of light emission and detection.

The parallel fabrication process for the flexible optical harness may include, for example, a rigid substrate, a separation or lift-off layer, a means of dispensing liquid monomer material onto said rigid substrate or separation layer that may include a spinning process, or a meniscus coating process, a heating means, a lithographic process means for polymerizing the monomer, including an ultraviolet source of light, a lithographic mask for defining the light path in the core material, and a development process that can be either positive tone or negative tone. Lasers and detectors may be first placed on the substrate or lift-off layer, a lower cladding layer is deposited and polymerized, a core material layer is deposited and the lithographic mask and ultraviolet source of light are used to selectively polymerize portions of the monomer and define the optical path between laser and photodetector. Upon development of the light path in the core layer, the laser and photodetector become self aligned to the light path and optically linked to one another. A top cladding layer may be applied and additional layers may be applied for protection. The lift-off layer may be separated from the rigid substrate at this point in order to form a flexible optical array having pre-aligned lasers and detectors.

Consistent with the embodiments of the present invention, a method for transmitting a high volume of information at high rates and at low cost may be provided by the optical harness. The optical harness may be in the form of a flexible array of light guiding conduits that are pre-aligned to lasers and detectors during a parallel fabrication process. This enables the simultaneous alignment of many optical channels with their respective lasers and detectors. The parallel, self-aligning fabrication process is efficient, scalable to many channels, and produces a high density of optical interconnects. The process is as applicable to the flexible optical harness as it is for fabricating optical lightwave circuits on rigid substrates.

Consistent with embodiments of the invention, a new structure and method of optically coupling light-guiding conduits and lasers and detectors of various constructions may be presented as a radical departure from present practices. Application of the principles disclosed herein enable mass production of high density opto-electronic circuits that are either flexible or rigid.

Accordingly, embodiments of the invention may provide, for example, a method for combining electrical and optical links on a flexible substrate. A method for linking computer boards as in blade servers with flexible, high speed, high density, low profile, mass produced, optical data links. A method for linking multiple processors on a computer board or on a ceramic package with highly dense arrays of optical interconnects is provided.

Consistent with embodiments of the invention, the optical transceiver may be configured to provide high speed optical signaling between electronic circuit boards and/or low speed electrical signaling between electronic circuit boards. For example, the smallest unit of data is referred to as a bit. A signal level “high” is generally referred to as a “bit 1” and a signal level “low” is generally referred to as a “bit 0”. Speed refers to the rate at which bits are transmitted from a first physical location to a second physical location. The higher the speed, the temporally narrower the bit duration becomes. For example, “high speed” refers to rates of bit transmission that are substantially one billion (10⁹) bits per second or greater and low speed refers to rates of bit transmission that are substantially less than one billion (10⁹) bits per second.

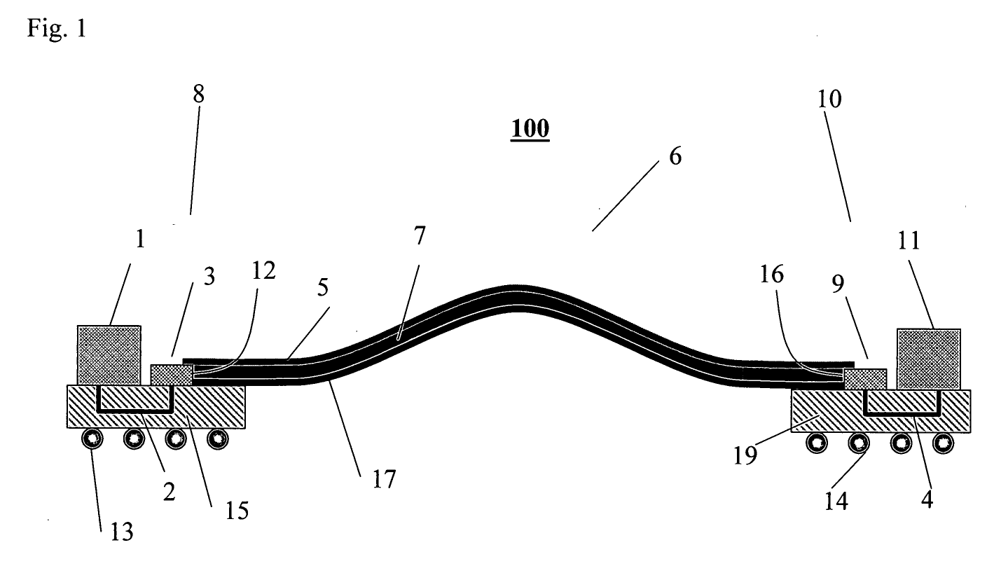

FIG. 1 shows a cross-section view of a flexible optical link transceiver optical harness 100. A semiconductor laser 3 forms an interface 12 with a light guiding structure 7 and a photodetector 9 forms an interface 16 with the same light guiding structure 7 at some distance from the laser 3. The light guiding structure 7 may, for example, comprise a first core light guiding volume and a second surrounding cladding volume whose index or refraction is less than that of the first core material. A third protective volume 5 may be added. Portions of the light guiding region may be formed on rigid substrates 15 and 19 and portions may be formed on a flexible substrate 17 spanning the region 6 between the optical transmitter module 8 and receiver module 10. Transmitter and associated electronics may be formed on a substrate 15 of transmitter module 8. The transmitter module may contain the laser light source 3, and circuit 1 for powering and encoding light emanating from laser source 3. Structure 2 is representative of a circuit for providing power and encoded signals to laser light source 3, while structure 13 is representative of a circuit for providing electrical connections between a transmitting electronic circuit on a separate substrate (not shown) and the optical transmitter module 8. Receiver and associated electronics may be formed on substrate 19 of receiver module 10. The receiver module may contain a photodetector receiver 9, and circuit 11 for powering receiver 9 and amplifying signal from receiver 9. Structure 4 is representative of electrical circuit for providing power and receiving encoded signals from photodetector 9, while structure 14 is representative of a circuit for providing electrical connections between a receiving electronic circuit on a separate substrate (not shown) and the optical receiver module 10.

Consistent with embodiments of the invention, the light guiding structure 7 may comprise a first material and the laser 3 may comprise a second material forming a first-material-to-second material interface. Furthermore, the light guiding structure 7 may comprise the first material and the photodetector 9 may comprise the second material forming a first-material-to-second material interface. The first material may comprise a material that is essentially transparent to a range of wavelengths that contain the wavelength of the light in use. For example, a polymer material in the wavelength range of 700 nm to 1500 nm, or fused silica glass in the wavelength range 300 nm to 2000 nm, or a silicon semiconductor material in the wavelength range 1100 nm to 1600 nm. The second material may comprise a semiconductor, or layers of semiconductor alloys, for example, layers of various compositions of Indium Gallium Arsenide (In₍ₓ₎Ga₍₁₋ₓ₎As). The subscript (x) denotes the fractional content of Indium in the Indium Gallium Arsenide alloy. The second material may further comprise an insulator material layer on the semiconductor or layers of semiconductor alloys.

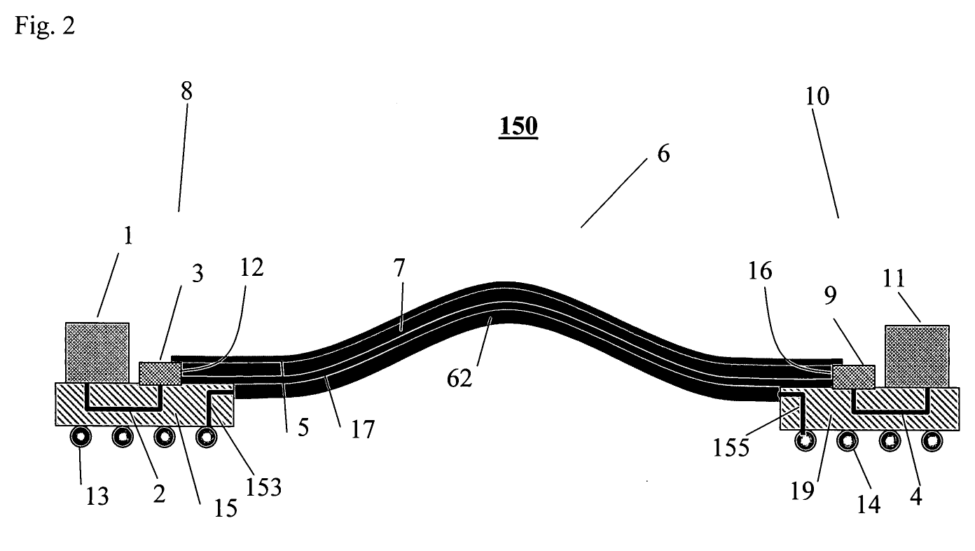

FIG. 2 shows a cross section view of a flexible optical link transceiver 150. In this case a volume 62 is added which may be used for electrically connecting portions of the transmitter module 8 and receiver module 10. In addition, structures 153 and 155 represent electrical connections between transmitter module 8 and receiver module 10 that may be used to communicate additional electrical signals to the electrical circuits (not shown) to which module 8 and module 10 may be connected via structures 13 and 14.

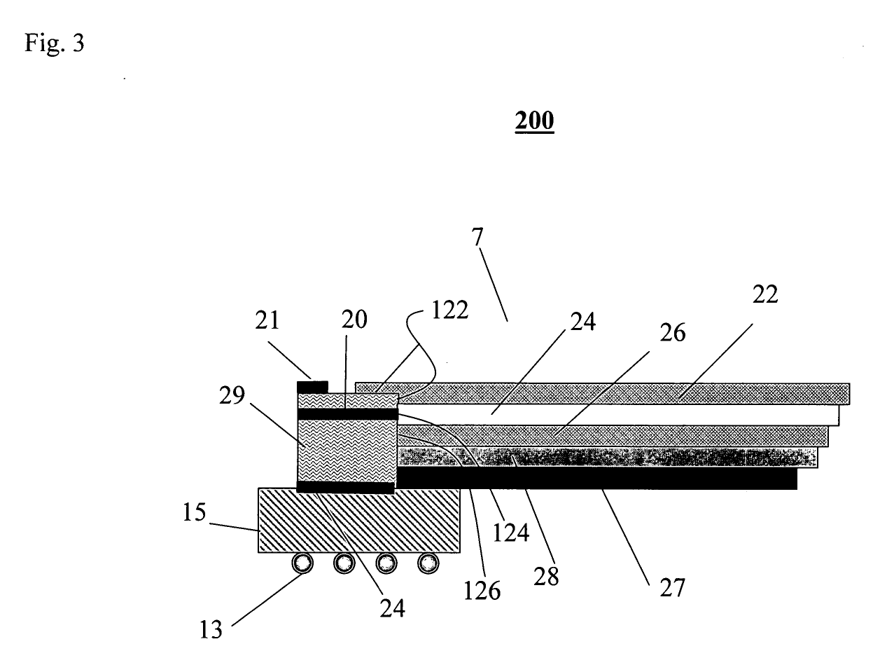

In FIG. 3 drawing 200 is shown a detail cross section of a coupling interface between an active optoelectronic device 29, in this case an edge emitting laser, and the light guiding structure 7. Volume 24 of the light guiding structure 7 may represent a light guiding core having an index of refraction larger than that of the surrounding cladding volumes 22 and 26. Volumes 24, 22 and 26 comprise the light guiding structure 7 and each may form an interface 122, 124 and 126 with laser optoelectronic device 29. In device 29, structures 21 and 24 represent top and bottom electrical contacts of the edge emitting laser and 20 represent the laser waveguide through which light is emitted in a substantially horizontal direction. Volume 28 may represent a buffer layer that provides a smooth surface and volume 27 may be a flexible supporting layer.

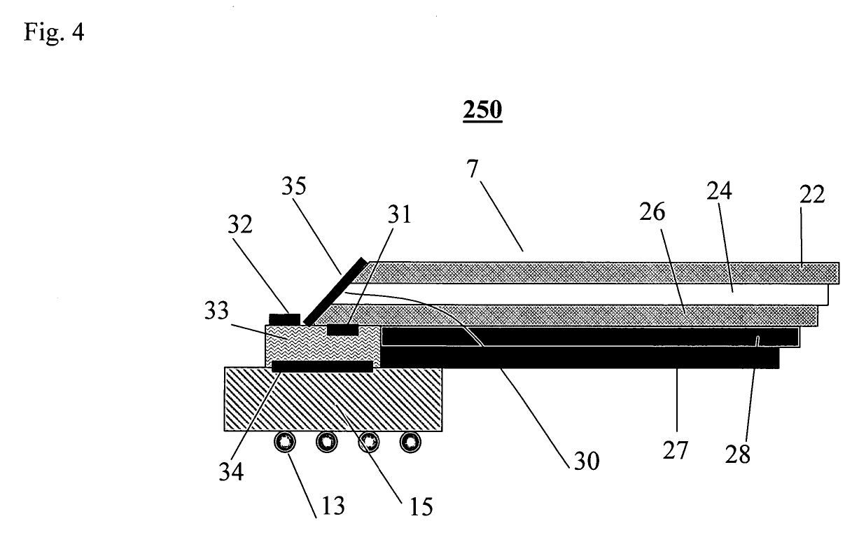

In FIG. 4 drawing 250 shows a cross section detail of a coupling interface between a surface emitting laser 33 and the light guiding structure 7, similar to that discussed in conjunction with FIG. 3. The volumes 22, 24, 26, 28, 27 may be similar to those discussed in connection to FIG. 3. The surface emitting laser has top and bottom electrical contacts 32 and 34 and light emitting region 31 out of which light emanates in a substantially vertical direction. In this case, volume 26 or volume 24 may form an interface with the laser emitting surface 31. The angled surface 30 supports light reflection from the source 31 into the core 24 of the light guiding structure 7. The light reflection may be augmented by use of additional reflecting surface 35.

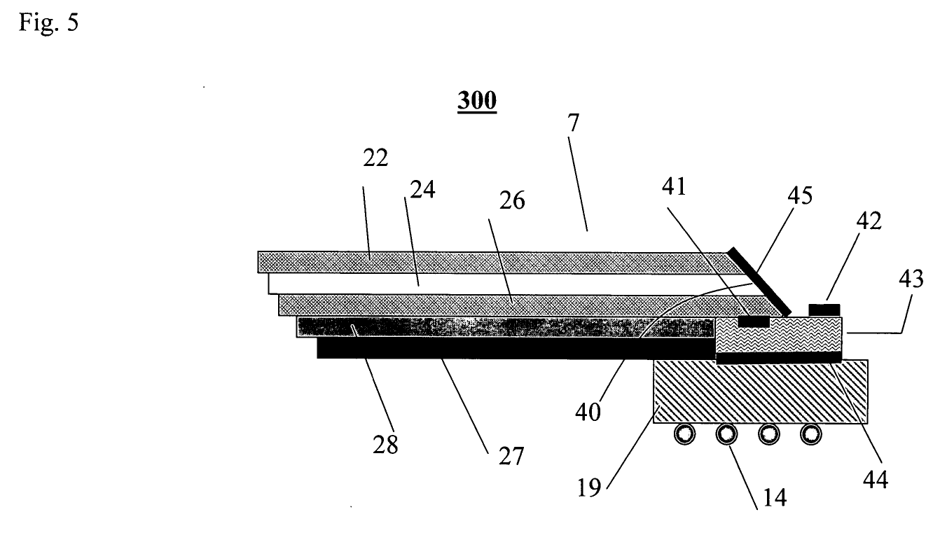

Having described the optical interface between the light guiding structure 7 and edge-emitting and surface-emitting laser sources, the interface between the light guiding structure 7 and surface viewing and edge viewing photodetector receiver structures will be described. In FIG. 5 the drawing 300 shows the interface between light guiding structure 7 and a surface-viewing photodetector 43 that is constructed to receive light in a substantially vertical direction, as viewed in FIG. 5. As in FIG. 4, the angled surface 40 supports light reflection, in this case from the core 24 of the light guiding structure 7 to the detector front active surface 41. The light reflection may be augmented by use of additional reflecting surface 45. In this case, surface-viewing photodetector 43 has top and bottom electrical contacts 42 and 44. As in the discussion in conjunction with FIG. 4 volume 26 or volume 24 may form an interface with the photodetector active area 41.

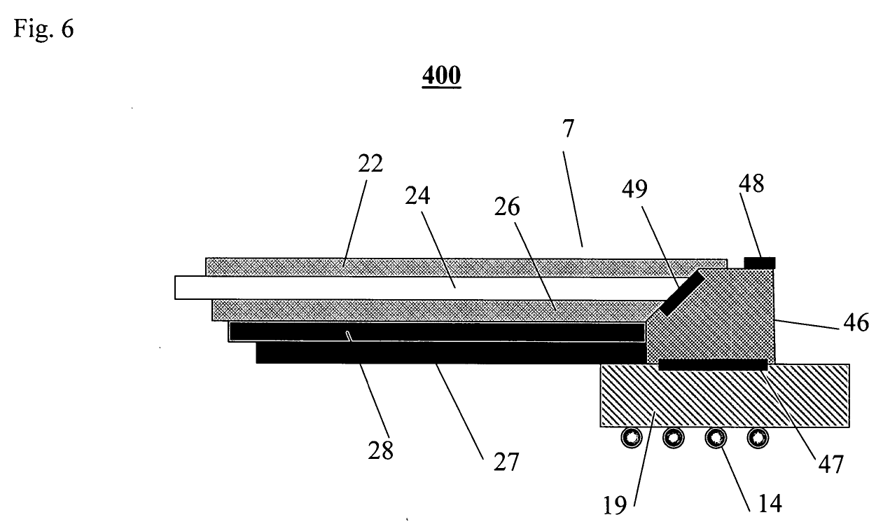

In another embodiment, shown in FIG. 6, the active area 49 of the edge-viewing photodetector 46 forms an interface with the core volume 24 of the light guiding structure 7. Structures 48 and 47 form the top and bottom electrical contacts. Cladding volumes 22 and 26 of the light guiding structure 7 may also form an interface with edge-viewing photodetector 46.

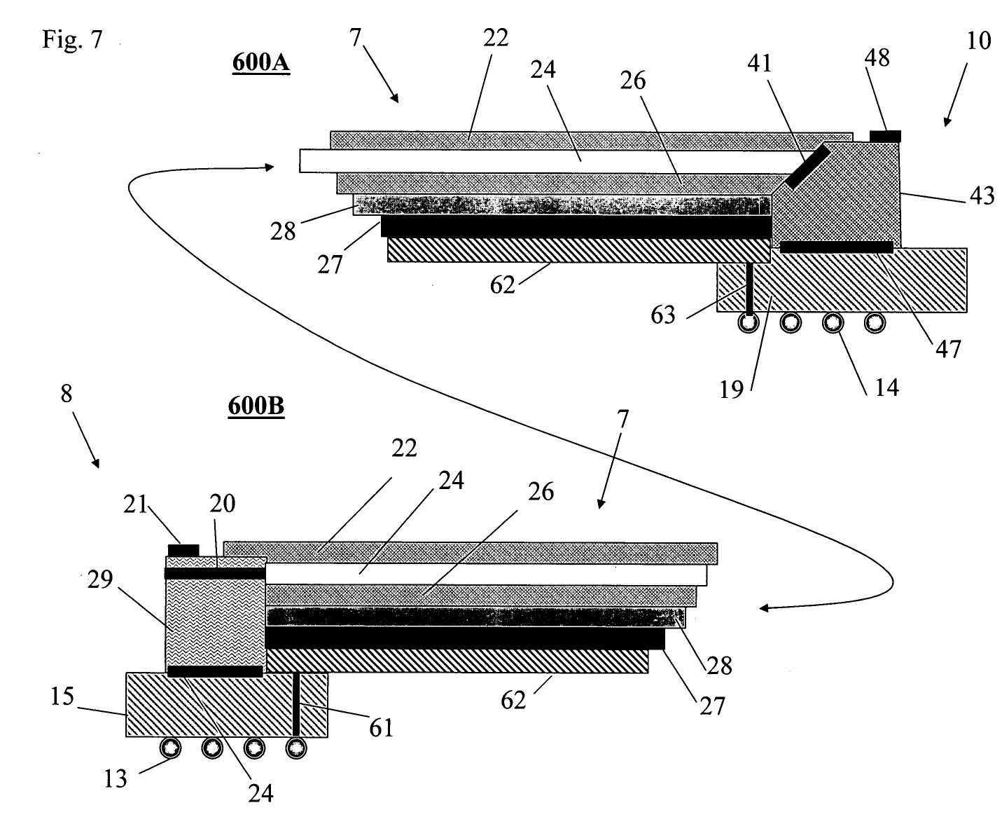

FIG. 7 shows cross section views of another embodiment of the combined electrical and optical layers. In this particular embodiment the electrical layer 62 makes contact with transmitter module rigid substrate portion 15 and with receiver module rigid substrate portion 19. Structures 61 and 63 represent electrical connections from electrical layer 62 to an electrical circuit segment (not shown) via modules 8 and 10. In drawing 600A are shown the electrical connections to the receiver module 10 and the optical interface between light guiding structure 7 and edge-viewing photodetector structure 46 as in FIG. 6. In drawing 600B are shown the electrical connections to the transmitter module 8 and the optical interface between light guiding structure 7 and edge emitting laser 29, as in FIG. 3. The double arrow curve is meant to indicate continuity of all layers 22, 24, 26, 28, 27 and 62.

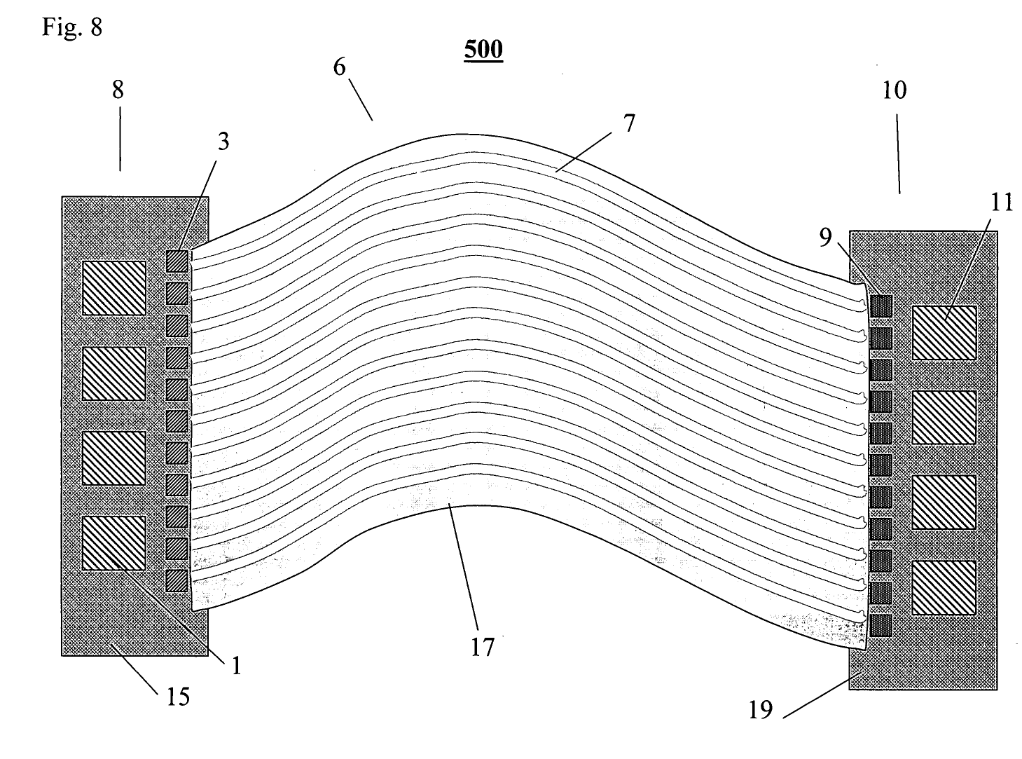

FIG. 8 shows a mostly top view 500 of the embodiment shown in FIG. 1. FIG. 8 is intended to emphasize that an embodiment of the invention may contain multiple parallel light guiding channels 7 formed on a flexible substrate 17 described in the preceding Figures. Structures 1, 6, 15, 3, 8, 9, 10, 11 and 19 represent similar structures as those structures identified by the same numbers in FIG. 1. The interfaces between lasers and photodetectors are as described in FIGS. 3-7.

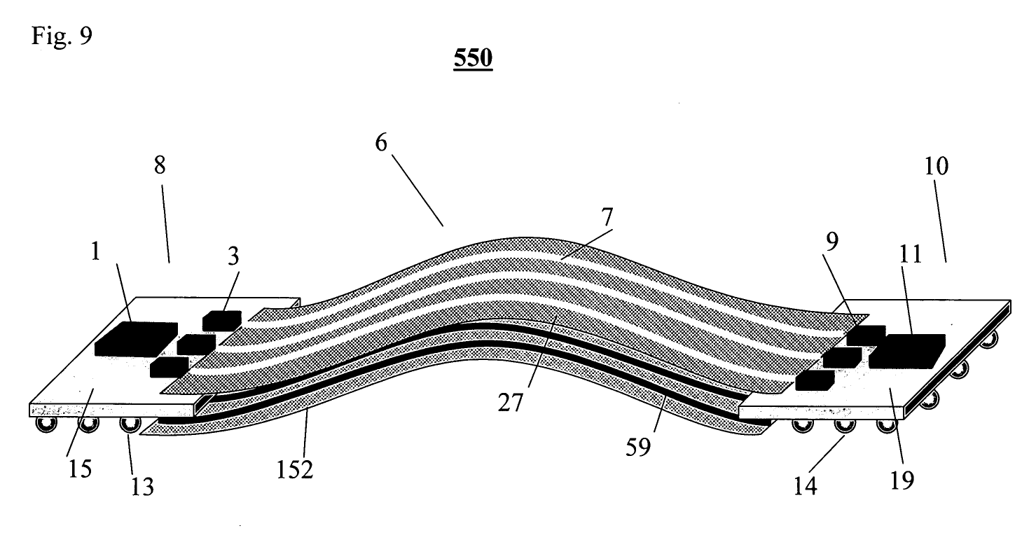

FIG. 9 shows a perspective view 550 of FIG. 2 in which relation between the optical flexible layer and electrical flexible layer are more easily viewed. In FIG. 9, the conducting wires 59 are more clearly identified in the electrical flexible layer 152. Even though the flexible portions of optical layer 27 and electrical layer 152 appear on opposite sides of rigid substrate portions 15 and 19, this separation is made for clarity. Flexible substrate portions 27 and 152 may be bonded together. Flexible layer 152 and electrical wires 59 comprise the layer 62 in FIGS. 2 and 7.

It is intended, therefore, that the specification and examples be considered as exemplary only, with a true scope and spirit of the invention being indicated by the following claims and their full scope of equivalents.

What is claimed is:

1. An optical transceiver for providing optical communication, the transceiver comprising:
at least one laser;
at least one photodetector;
at least one light guiding structure wherein a first end of the at least one light guiding structure connects to the at least one laser and a second end of the at least one light guiding structure connects to the at least one photodetector;
at least one supporting structure;
a first circuit configured for activating the at least one laser;
a second circuit configured for detecting light impingent on the at least one photodetector;
a first material interface between the at least one light guiding structure and the at least one laser; and
a second material interface between the at least one light guiding structure and the at least one photodetector wherein light produced by the at least one laser is substantially contained within the at least one light guiding structure from the at least one laser to the at least one photodetector.

2. The optical transceiver of claim 1 wherein the at least one supporting structure provides mechanical support for the at least one laser, the at least one photodetector, and the at least one light guiding structure.

3. The optical transceiver of claim 2 wherein the at least one supporting structure provides mechanical support for at least one electrically conductive line between a transmitter module of the optical transceiver and a receiver module of the optical transceiver.

4. The optical transceiver of claim 2 wherein the at least one supporting structure comprises a plurality of layers configured to protect the at least one electrically conductive line.

5. The optical transceiver of claim 1 wherein at least a portion of the at least one supporting structure is substantially mechanically flexible.

6. The optical transceiver of claim 1 wherein at least a portion of the at least one supporting structure is substantially mechanically rigid.

7. The optical transceiver of claim 1 wherein the at least one supporting structure mechanically supports at least one of the following: the first circuit and the second circuit.

8. The optical transceiver of claim 1 wherein the at least one supporting structure comprises a plurality of layers configured to protect the at least one light guiding structure.

9. The optical transceiver of claim 1 wherein at least a portion of a light emitting facet of the at least one laser is substantially contained within the at least one light guiding structure.

10. The optical transceiver of claim 1 wherein a photo-active area of the at least one photodetector is substantially contained within the at least one light guiding structure.

11. The optical transceiver of claim 1 wherein at least a portion of a light emitting facet of the at least one laser and the photo-active area of the at least one photodetector are both substantially contained within the at least one said light guiding structure.

12. The optical transceiver of claim 1 wherein the at least one light guiding structure comprising a first material and the at least one laser comprising a second material form a first-material-to-second material interface wherein the first material is essentially transparent to a range of wavelengths that contain the wavelength of the light in use and the second material comprise one of the following: a semiconductor and layers of semiconductor alloys and insulator layer.

13. The optical transceiver of claim 1 wherein the at least one light guiding structure comprising a first material and the at least one photodetector comprising a second material form a first-material-to-second material interface wherein the first material is essentially transparent to a range of wavelengths that contain the wavelength of the light in use and the second material comprise one of the following: a semiconductor and layers of semiconductor alloys and insulator layer.

14. The optical transceiver of claim 1 wherein the at least one laser is an edge-emitting laser.

15. The optical transceiver of claim 1 wherein the at least one photodetector is an edge viewing photodetector.

16. The optical transceiver of claim 1 configured for at least one of the following: high speed optical signaling between electronic circuit boards and low speed electrical signaling between electronic circuit boards wherein high speed comprises rates of bit transmission of one billion (10⁹) bits per second or greater and low speed comprises rates of bit transmission of less than one billion (10⁹) bits per second.

17. The optical transceiver of claim 1 configured for at least one of the following: high speed optical signaling between different portions of the same electronic circuit board and low speed electrical signaling between the different portions of the same electronic circuit board.

18. The optical transceiver of claim 1 further comprising at least one of the following: at least one first connector configured to connect a transmitter module included in the optical transceiver to elements outside the optical transceiver and at least one second connector configured to connect a receiver module of the optical transceiver to elements outside the optical transceiver.

19. An optical transceiver for providing optical communication, the transceiver comprising:
a plurality of lasers;
a plurality of photodetectors;
a plurality of light guiding structures wherein first ends of the plurality of light guiding structures respectively connect to the plurality of lasers and second ends of the plurality of light guiding structures respectively connect to the respectively photodetectors;
a supporting structure;
first circuit respectively configured for activating the plurality of laser;
second circuit respectively configured for detecting light impingent on the plurality of photodetectors;
first material interfaces between the plurality of light guiding structures and the plurality of lasers; and
second material interfaces between the plurality of light guiding structures and the plurality of photodetectors wherein the plurality of light guiding structures are substantially composed of a polymer material and light produced by each of the plurality of lasers is substantially contained within each of the plurality of light guiding structures from the plurality of lasers to the plurality of photodetectors wherein each of the first and second material interfaces is spatially separated from its nearest neighboring first or second material interface.

20. A method for providing optical communications using an optical transceiver, the method comprising:
transceiving optical communications between at least one laser and at least one photodetector included in the optical transceiver, the optical transceiver further comprising,
at least one light guiding structure wherein a first end of the at least one light guiding structure connects to the at least one laser and a second end of the at least one light guiding structure connects to the at least one photodetector;
at least one supporting structure,
a first circuit configured for activating the at least one laser,
a second circuit configured for detecting light impingent on the at least one photodetector,
a first material interface between the at least one light guiding structure and the at least one laser, and
a second material interface between the at least one light guiding structure and the at least one photodetector wherein the at least one light guiding structure is substantially composed of a polymer material and light produced by the at least one laser is substantially contained within the at least one light guiding structure from the at least one laser to the at least one photodetector.
